(19) United States
(12) Patent Application Publication
(10) Pub. No.: US 2025/0239869 A1
(43) Pub. Date: Jul. 24, 2025

(54) ACTIVE INTER-CELL BALANCING METHOD

(71) Applicant: Caterpillar Inc., Peoria, IL (US)

(72) Inventors: Wellington Ying-wei Kwok, Dunlap, IL (US); Jeffrey T. Abney, Morton, IL (US)

(73) Assignee: Caterpillar Inc., Peoria, IL (US)

(21) Appl. No.: 18/417,368

(22) Filed: Jan. 19, 2024

(51) Int. Cl. H02J 7/00; B60L 58/12; B60L 58/22; H01M 10/44; H01M 10/46; H01M 50/51; H02J 7/34

(52) U.S. Cl. CPC H02J 7/0019; B60L 58/12; B60L 58/22; H01M 10/441; H01M 10/46; H01M 50/51; H02J 7/0024; H02J 7/0048; H02J 7/00712; H02J 7/342; H02J 7/345; B60L 2200/40

(57) ABSTRACT

An energy cell system includes multiple energy cell strings, multiple switching modules, and a control circuit. Each of the energy cell strings includes multiple energy cells connected in series and the multiple switching modules are connected between the multiple energy cells of different energy cell strings. The control circuit is configured to detect a charge level of a first subset of one or more energy cells of a first energy cell string, activate a switching module to connect a second subset of one or more energy cells of another energy cell string to the first subset of energy cells to change the charge level of the first subset of energy cells, and deactivate the switching module in response to the change in the charge level of the first subset of energy cells.

### TECHNICAL FIELD

This document relates to rechargeable energy cell technology and in particular to techniques of balancing the state of charge of the energy cells when the energy cells are connected in series as strings of energy cells to power large work machines.

### BACKGROUND

Powering a large moving work machine (e.g., a wheel loader) with an electric motor requires a large mobile electric energy source that can provide current of tens to hundreds of Amperes (Amps). Multiple large capacity energy cells such as battery cells can be connected in series as energy cell strings, and the energy cell strings can be connected in parallel to connected provide the sustained energy power needed by a large electric-powered moving work machine. However, when multiple energy cell strings are connected together it is desirable to charge the energy cells in a manner that avoids large differences in the state of charge of the energy cells that could cause large inrush currents that could potentially damage the energy cells.

### SUMMARY OF THE INVENTION

Electric powered work machines use large capacity energy cell systems to power the work machines. The energy cells of a large capacity energy cell system should be balanced in their state of charge when brought online.

An example energy cell system includes multiple energy cell strings, multiple switching modules, and a control circuit. Each of the energy cell strings includes multiple energy cells connected in series and the multiple switching modules are connected between the multiple energy cells of different energy cell strings. The control circuit is configured to detect a charge level of a first subset of one or more energy cells of a first energy cell string, activate a switching module to connect a second subset of one or more energy cells of another energy cell string to the first subset of energy cells to change the charge level of the first subset of energy cells, and deactivate the switching module in response to the change in the charge level of the first subset of energy cells.

### BRIEF DESCRIPTION OF THE DRAWINGS

FIG. 1 is an elevation view depicting an example work machine in accordance with this disclosure.

FIG. 2 is a block diagram of an example of an energy cell system in accordance with this disclosure.

FIG. 3 is a block diagram of another example of an energy cell system in accordance with this disclosure.

FIG. 4 is a circuit diagram of an example of a switching module in accordance with this disclosure.

FIG. 5 is a flow diagram of an example of a method of operating an energy cell system in accordance with this disclosure.

FIG. 6 illustrates an example of activating equipotential switching modules of an energy cell system in accordance with this disclosure.

FIGS. 7-10 are additional examples of activating switching modules of an energy cell system in accordance with this disclosure.

FIG. 11 shows an example of an energy cell system with a defective switching module in accordance with this disclosure.

FIGS. 12A and 12B are diagrams of examples of dual energy cell systems in accordance with this disclosure.

FIG. 13 is a block diagram of another example of a dual energy cell system in accordance with this disclosure.

FIG. 14 shows graphs of the open circuit voltage profiles as a function of state of charge for two types of energy cells in accordance with this disclosure.

FIGS. 15 and 16 are illustrations of additional examples of dual energy cell systems in accordance with this disclosure.

FIG. 17 is a flow diagram of an example of a method of operating a dual energy cell system in accordance with this disclosure.

FIG. 18 is an illustration of an example of an initial charged condition and the switching modules of a dual energy cell system in accordance with this disclosure.

FIGS. 19A and 19B are graphs of the simulated response of a constant-current discharge profile of the dual energy cell system in accordance with this disclosure.

FIG. 20 is an illustration of an example of charge equalization of individual cell segments of the energy cell strings of a dual energy cell system using equipotential switching modules in accordance with this disclosure.

FIGS. 21 and 22 are illustrations additional examples of activating switching modules to shuttle charge between energy cell strings of a dual energy cell system in accordance with this disclosure.

### DETAILED DESCRIPTION

Examples according to this disclosure are directed to methods and systems for automatically balancing the energy cells of a large capacity energy cell system.

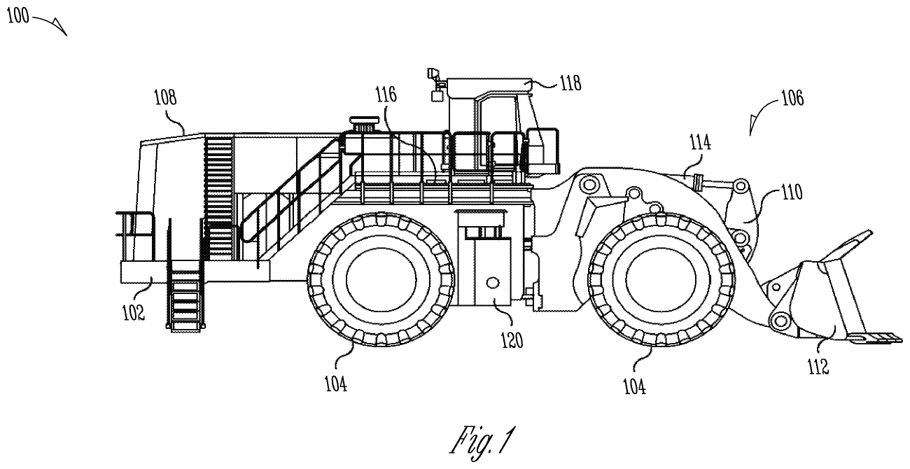

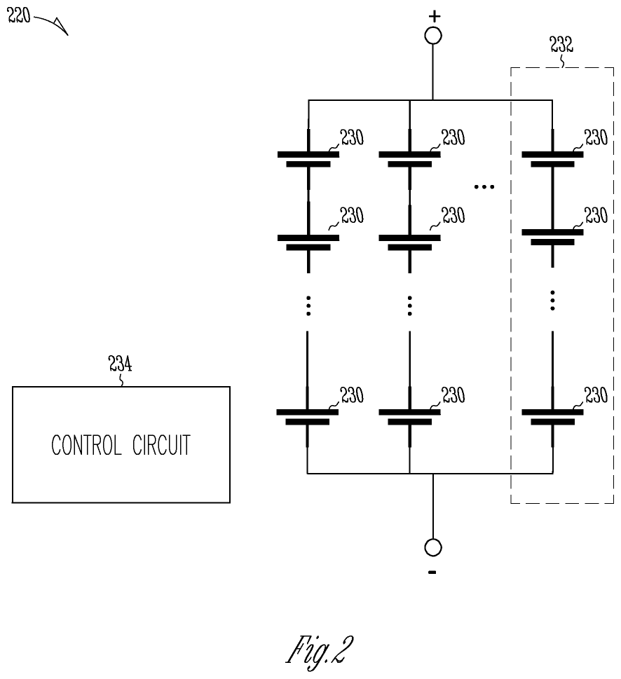

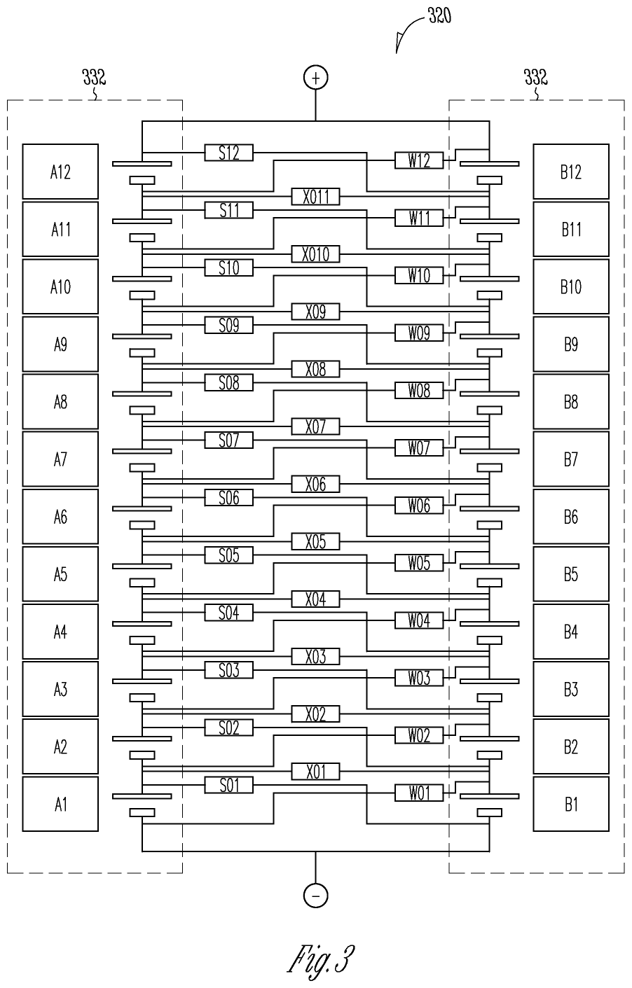

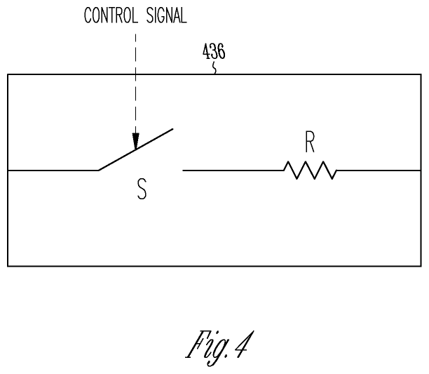

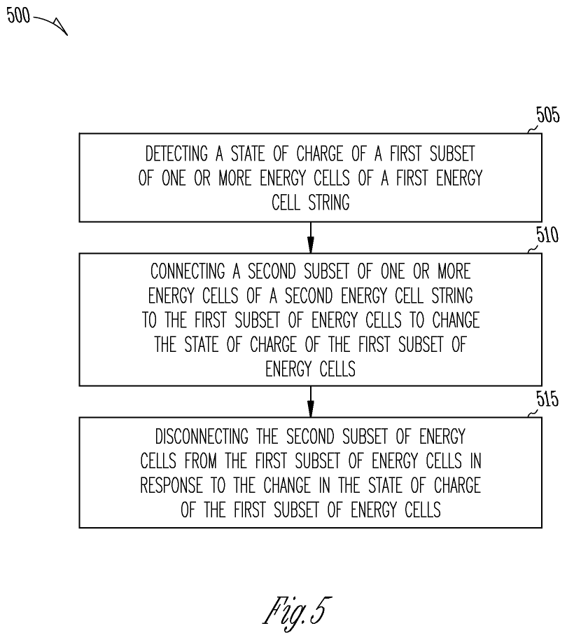

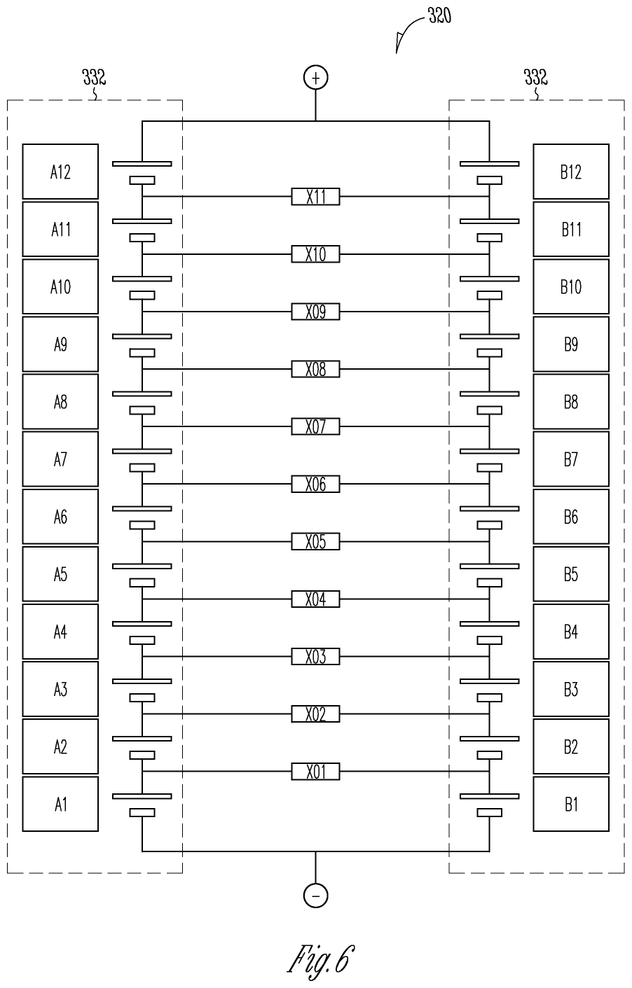

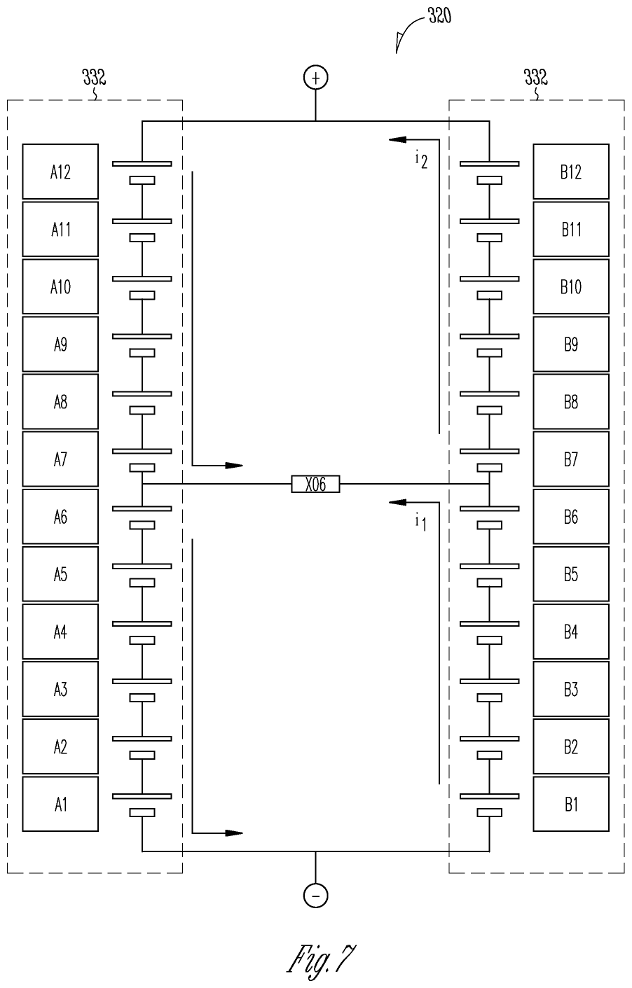

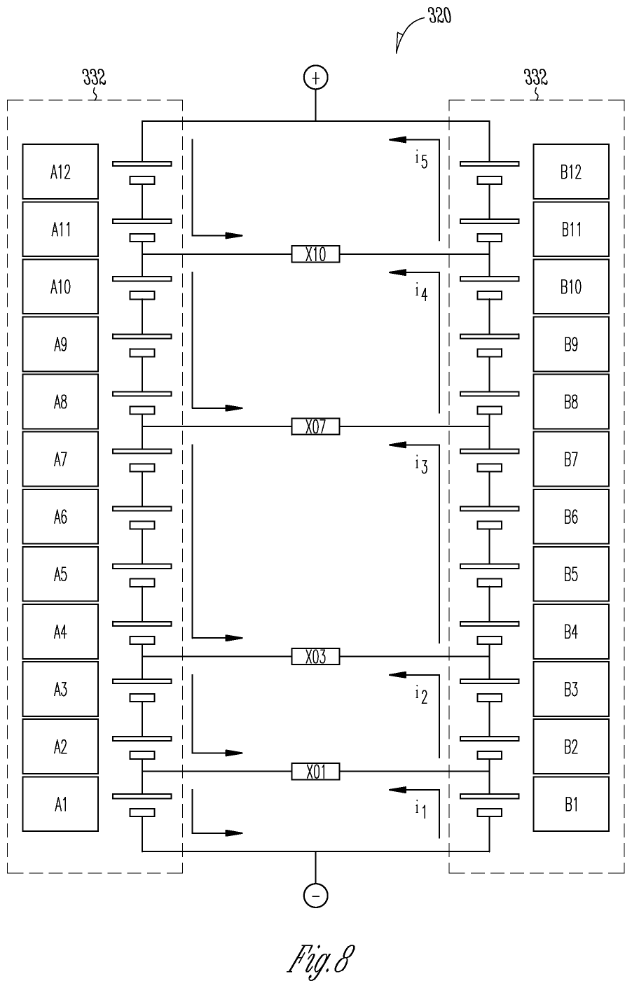

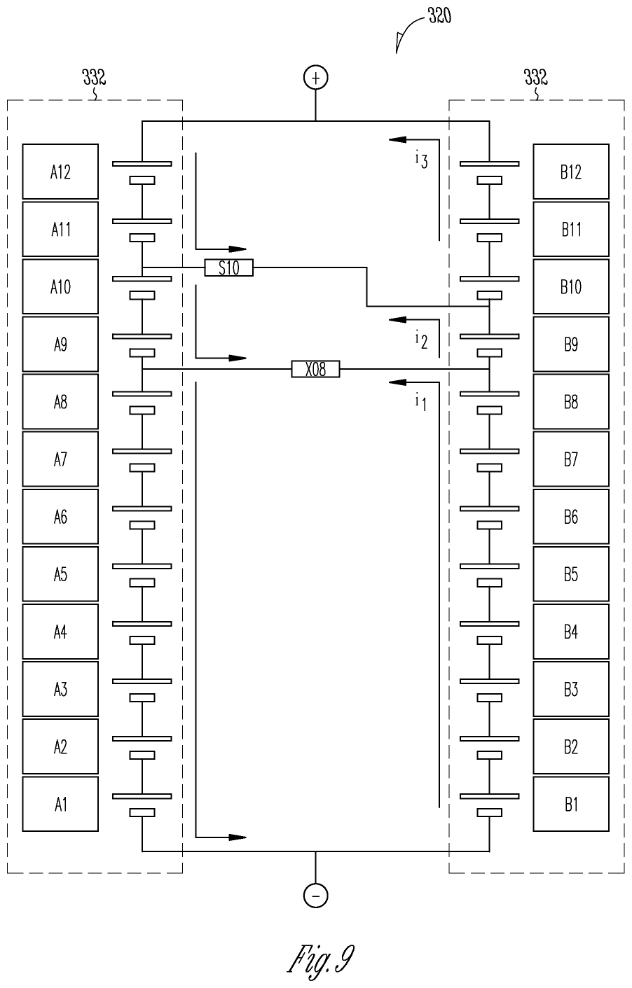

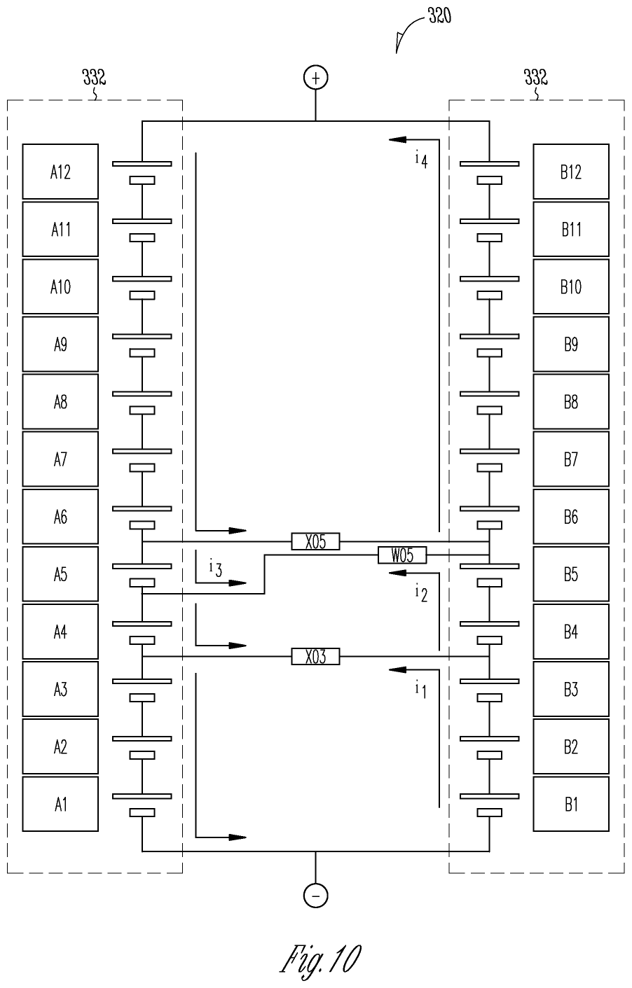

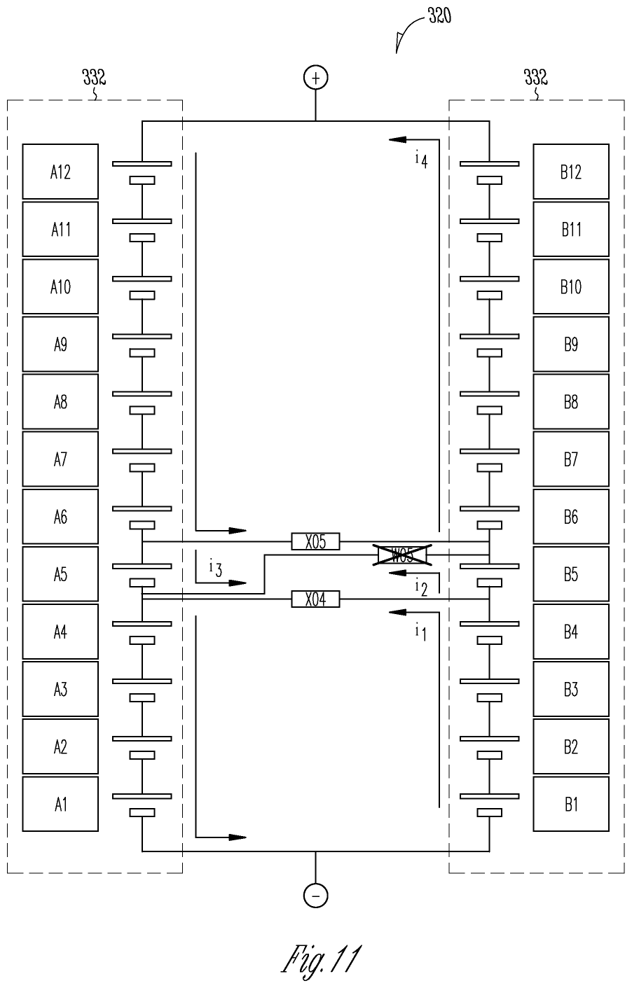

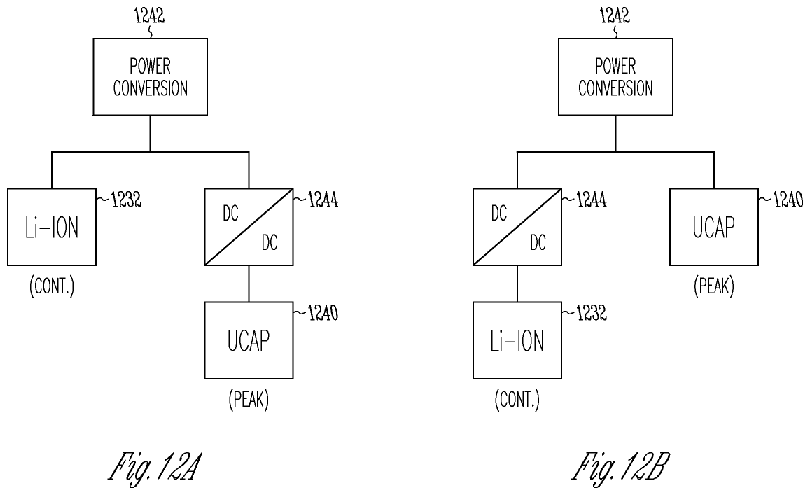

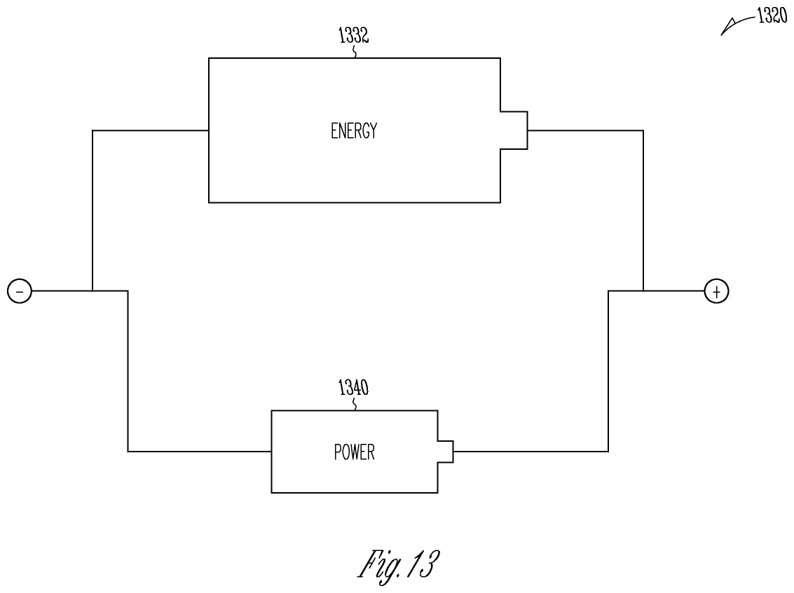

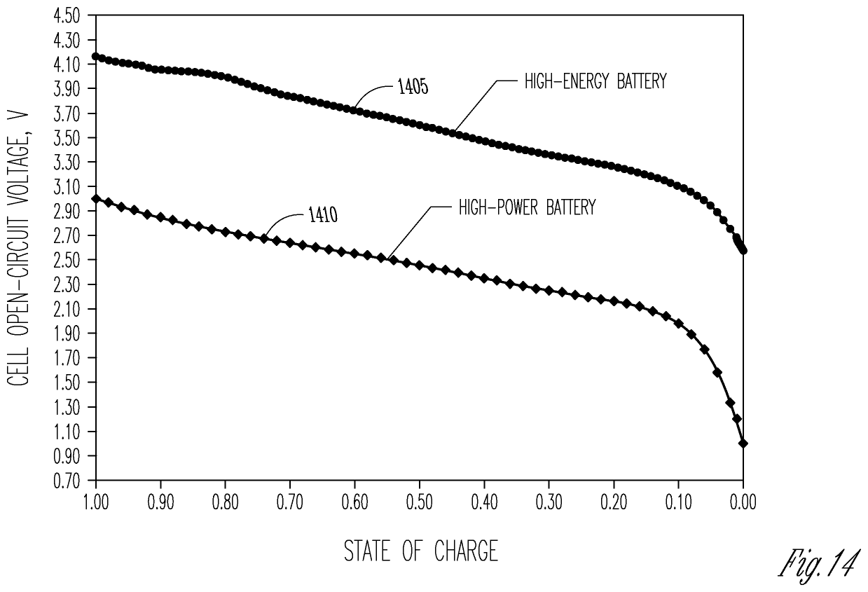

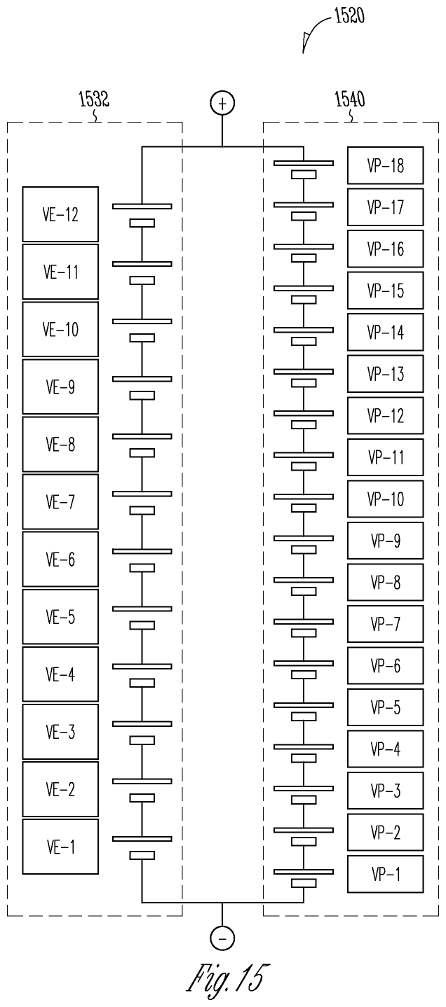

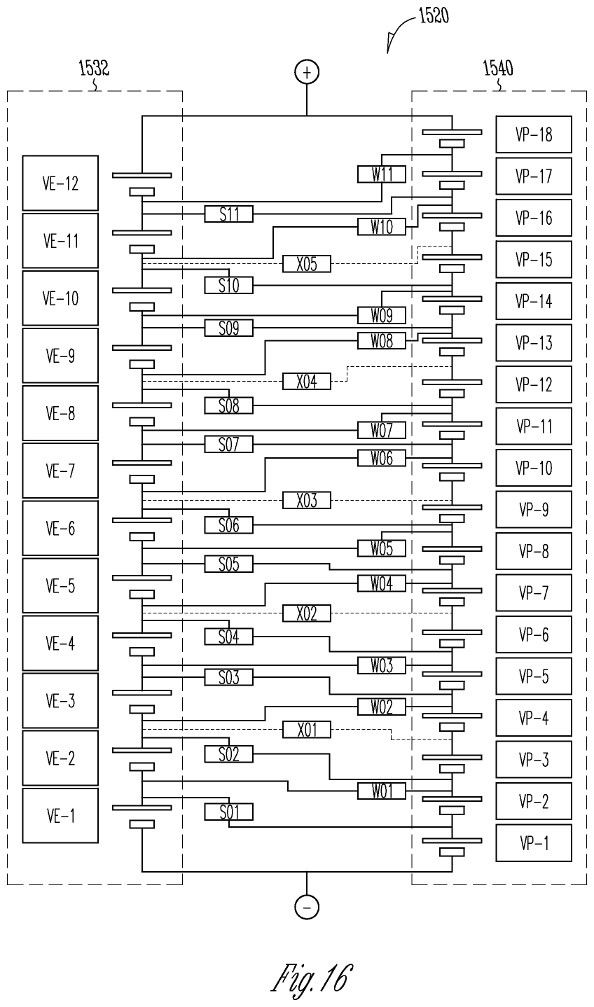

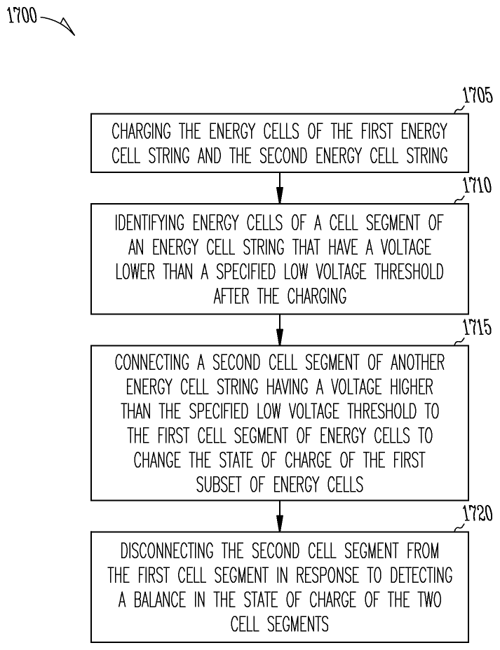

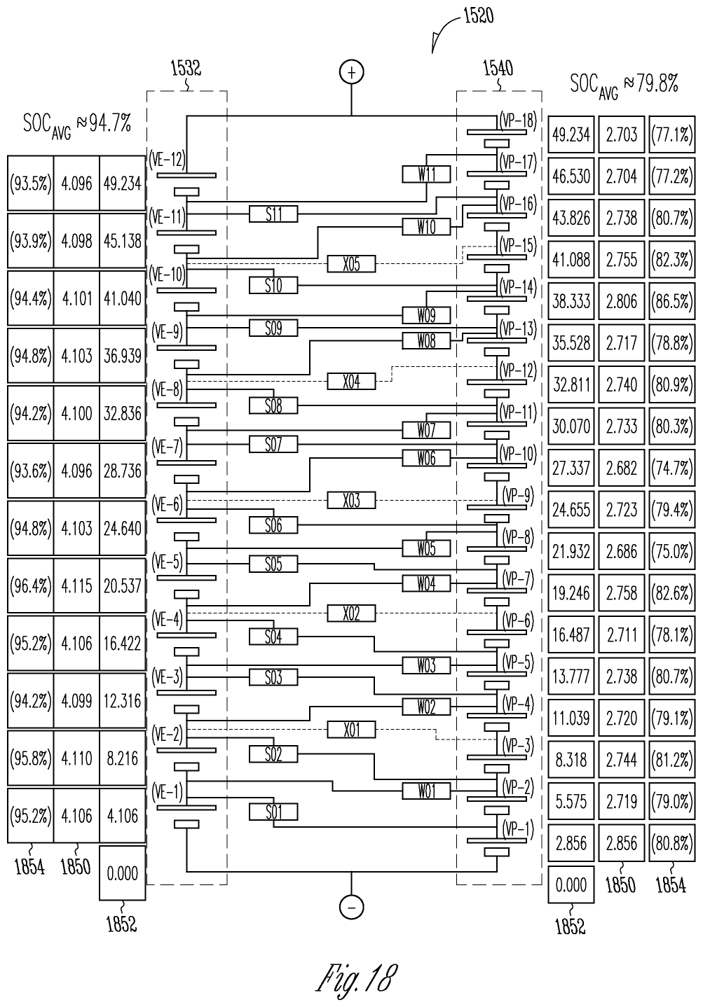

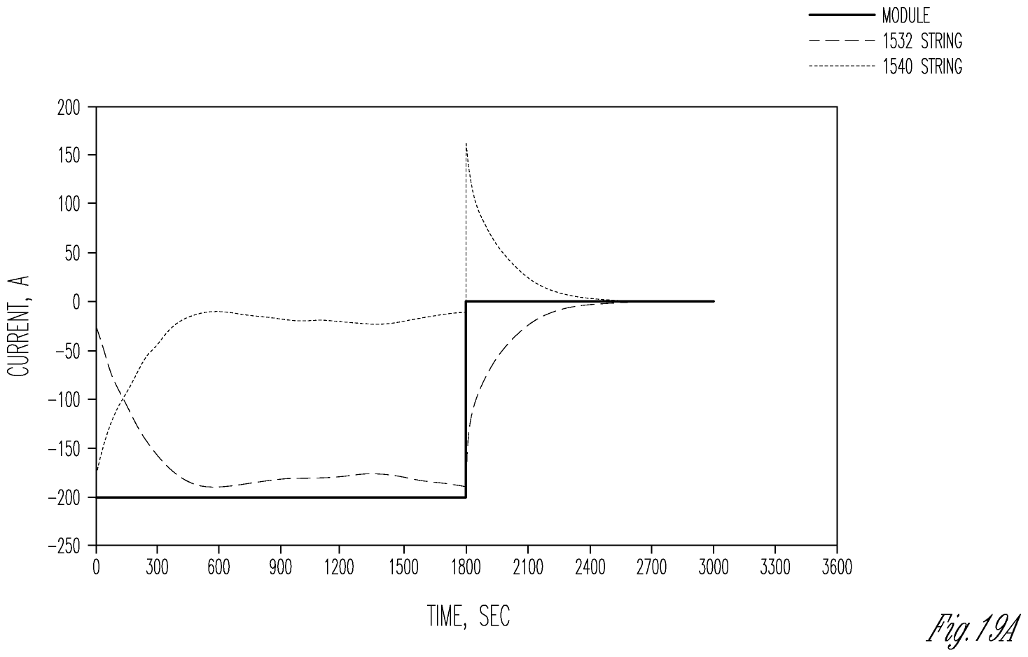

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, and so on. Accordingly, although a number of examples are described with reference to a wheel loader machine, examples according to this disclosure are also applicable to other types of machines including graders, scrapers, dozers, excavators, compactors, material haulers like dump trucks, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. As an example, machine 100 can be used to excavate a portion of a work site by actuating cylinders 114 to articulate bucket 112 via linkage assembly 110 to dig into and remove dirt, rock, sand, etc. from a portion of the work site and deposit this load in another location.

Machine 100 can include a battery compartment connected to frame 102 and including a battery cell system 120. Battery cell system 120 is electrically coupled to the one or more electric motors of the machine 100.

In a typical large capacity energy cell system such as a large capacity battery cell system 120, individual energy cells are connected in a series-parallel configuration to form a high-voltage and high-energy multi-cell array. With manufacturing variance and environmental conditions, each energy cell within the multi-cell array could behave differently during charge-discharge cycling operations (due to the differences in cell capacity, impedance, temperature, etc.). This can result in state of charge (SoC) deviation between cells over time. The SoC of the cells of the system should be rebalanced from time to time to maintain proper operation.

FIG. 2 is a block diagram of an example of an energy cell system 220. The energy cell system 220 be used to provide power to a work machine, such as the example machine 100 of FIG. 1. The energy cell system 220 includes multiple energy cells 230. The energy cells are connected in series to form energy cell strings 232. The energy cells 230 may be battery cells (e.g., two to twelve 58 Volt, 80 Amp-hour batteries or 60 kilowatt-hour batteries in a battery cell string) or another type of energy cell. The energy cell system 220 includes multiple energy cell strings 232 (e.g., two to eight energy cell strings) connected in parallel.

The energy cell system 120 includes a control circuit 234 to bring the energy cell strings 232 online in a discharge state to provide electrical energy to a work machine and a charge state to recharge the energy cells. The control circuit 234 may include processing circuitry that includes logic to perform the functions described. The processing circuitry may include a microprocessor, application specific integrated circuit (ASIC), programmable gate array (PGA), or other type of processor, interpreting or executing instructions in software or firmware. In some examples, the control circuit 234 includes a logic sequencer circuit. A logic sequencer refers to a state machine or other circuit that sequentially steps through a fixed series of steps to perform the functions described. A logic sequencer circuit can be implemented using hardware, firmware, or software.

FIG. 3 is a block diagram of another example of an energy cell system 320. The energy cell system 320 includes two energy cell strings 332. There are an equal number of energy cells in the two strings. The first energy cell string (String A) includes twelve energy cells labeled A1 to A12 connected in series, and the second energy cell string (String B) includes twelve energy cells labeled B1 to B12 connected in series. The energy cells may be of the same energy cell type. For example, the energy cells of the energy cell strings may all be battery cells (e.g., Lithium-Ion battery (LIB) cells, Sodium-Ion battery (SIB) cells, Lead-Acid (PbA) battery cells, Nickel-Zinc (Ni—Zn) battery cells, Metal-Air battery cells, Solid-State battery (SSB) cells, etc.). In another example, the energy cells may be capacitive cells (e.g., Lithium capacitors (LiCap), super capacitors (SuperCap), ultra capacitors (UCap), etc.).

The energy cell String A is directly connected in parallel to the energy cell String B at the two terminals (+,−) of the energy cell system 320. The individual energy cells of String A are also connected to the individual energy cells of String B by multiple switching modules. The control circuit (not shown in FIG. 3) activates the switching modules such that charges on the energy cells can be transferred between energy cells or segments of cells of the different energy cell strings.

FIG. 4 is a circuit diagram of an example of a switching module 436. The switching module 436 includes a switch circuit S (e.g., a power field effect transistor (FET)) and a resistor R. The switch circuit S is activated by a control signal from the control circuit. The resistance of the resistor R is sized to limit the current flow between the energy cells.

Returning to FIG. 3, at the end of a charging cycle the energy cells may have different states of charge. If the difference between the charge is too great, the control circuit 234 activates switching modules to transfer charge from energy cells with higher charge to energy cells with lower charge until the energy cells are at nearly the same SoC. To monitor the SoC of the cells, the energy system 320 includes voltage sensors that are readable by the control circuit. The energy system 320 may include a voltage sensor for each energy cell, or the energy system can include less voltage sensor circuits than energy cells and one voltage sensor can be used to monitor the SoC of more than one energy cell.

The control circuit 234 detects the charge level of a first subset of the energy cells (e.g., an individual energy cell or a segment of energy cells of a string) using voltage sensors and activates one or more switching modules to connect one or more other cells to connect other energy cells of the other energy cell string to change the charge level of the subset of energy cells. One energy cell with higher voltage can be connected to an energy cell with lower voltage to shuttle the charge from the higher voltage cell to the lower voltage cell. Once the energy cells are at the same SoC or within a specified (e.g., programmed) threshold of charge, the control circuit 234 deactivates the switching modules in response to the change in the charge level.

Because there is an equal number of energy cells in the two energy cell strings 332, each energy cell of one string may be viewed as forming a pair with corresponding energy cell of the other energy string. For example, energy cells A1, B1 form an energy cell pair, A2, B2 form an energy cell pair, and so on.

There are three sets of switching modules connecting each of the energy cell pairs between the two strings. The first set of switching modules is labeled X01 to X11. This set of switching modules connects the cathode of an energy cell to the cathode of its corresponding pair. For example, switching module X01 connects the cathodes of energy cell pair A1, B1. The first set switching modules can be used as equipotential switching modules that balance the individual energy cell pair to the same voltage potential.

The second set of switching modules is labeled S01 to S12. This set of switching modules can be used as charge shuttling switching modules that allow current to flow from the energy cells of string A to the energy cells of string B. The second set of switching modules connects the cathode of an energy cell of String A to an anode of the corresponding parallel energy cell of String B. For example, switching module S01 connects the cathode of energy cell A1 to the anode of energy cell B1.

The third set of switching modules is labeled W01 to W12. This set of switching modules can be used as charge shuttling switching modules that allow current to flow from the energy cells of string B to the energy cells of string A. The third set of switching modules connects the anode of an energy cell of String A to the cathode of the corresponding parallel energy cell of String B. For example, switching module S01 connects the anode of energy cell A1 to the cathode of energy cell B1.

The control circuit activates switching modules to affect inter-cell charge balancing of parallel cells, or parallel cell segments, of the energy cell strings 332. The energy cells and switching modules of the energy cell system 320 form a series-parallel connected multi-cell array to store and shuttle electrical charges of the energy cells.

FIG. 5 is a flow diagram of an example of a method 500 of operating an energy cell system 320 that includes multiple energy cell strings 332 connected in parallel and includes switching modules to interconnect energy cells of the energy cell strings. The energy cell system 320 also includes a control circuit (e.g., the control circuit 234 of FIG. 2). The control circuit may receive a command to bring the energy cell system 320 to a charged state. The control circuit may then connect the energy strings of the battery system to an energy cell charger. The control circuit may connect one or more strings at a time to the charger.

At block 505, the control circuit detects the state of charge of the energy cells. In some examples, the control circuit monitors the output of voltage sensing circuits to detect the state of charge of a subset of the energy cells of the energy strings 332 of the energy cell system 320. The subset can include one or more energy cells of an energy cell string 332. The control circuit may monitor the state of charge of the energy cells in response to determining that the charging is complete, or in response to a command to place the energy system 320 to a state ready for discharging the energy cells.

At block 510, the control circuit activates one or more switching modules of the energy cell system to connect a subset of energy cells of another energy cell string to the first subset of energy cells to change the state of charge of the first subset of energy cells. For instance, in FIG. 3, the control circuit may identify energy cells of String B that have a voltage lower than a specified low voltage threshold after the charging of the String B. The control circuit may also identify energy cells of string A that have a voltage higher than the lower voltage cells. In certain examples, the control circuit identifies energy cells of string A that have a voltage higher than the specified voltage threshold or a different voltage threshold. In response to the detection of the lower voltage energy cells, the control circuit may activate one or more of switching modules S1-S12 to connect the higher voltage energy cells to the lower voltage energy cells to balance the state of change among the energy cells.

At block 515, the control circuit deactivates the switching modules to disconnect the energy cells of the two strings. The control circuit may monitor the state of charge of the energy cells using the voltage monitoring circuit and deactivate the switching modules in response to the change in state of charge of the connected energy cells.

FIG. 6 shows an example of activating all the equipotential switching modules X01-X11 to equalize state of charge of all the corresponding cell pairs of the two energy cell strings. For instance, activating all the switching modules labeled X01-X11 causes the voltage of energy cell A1 (V_{A1}) to equal the voltage of energy cell B1 (V_{B1}) and so on, so that V_{A1}=V_{B1}, V_{A2}=V_{B2}, . . . and V_{A12}=V_{B12}.

FIGS. 7 and 8 are more examples of activating switching modules to balance the state of charge of the energy cells of the energy cell strings. Cell segments of multiple energy cells can be balanced in one charge balancing process. In the example of FIG. 7, only equipotential switching module X06 is activated to equalize the bottom half the energy cell strings (with current i₁) and the top half of the energy cell strings (with current i₂). In the example of FIG. 8, the control circuit activates the equipotential switching modules X01, X03, X07, and X10 to equalize the charge in five cell segments (with currents i₁ through i₅).

FIG. 9 is another example of activating switching modules to balance the state of charge of the energy cells of the energy cell strings. In the example of FIG. 9, charge shuttling is produced by activation of shuttling switching module S10 and equipotential switching module X08. Charge is shuttled from the cell segment of A9 and A10 to energy cell B9 (with current i₂). Charge is also shuttled from the cell segment of B10, B11, and B12 to the cell segment of A11 and A12 (with current i₃). Charge between the cell segment of A1-A8 and the cell segment of B1-B8 is equalized by the activation of equipotential switching module X08 (with current i₁).

FIG. 10 is another example of activating switching modules to balance the state of charge of the energy cells of the energy cell strings. In the example of FIG. 10, charge shuttling is produced by activation of shuttling switching module W05 and equipotential switching modules X03 and X05. Charge is shuttled from the cell segment of B4 and B5 to energy cell A4 (with current i₂), and energy cell A5 is passively discharged (with current i₃) using the loop of switching modules W05 and X05. Charge between the cell segment of A1-A3 and the cell segment of B1-B3 is equalized by equipotential switching module X03 (with current i₁), and the charge between the cell segment of A6-A12 and the cell segment of B6-B12 is equalized by equipotential switching module X05 (with current i₄). The control circuit may use different techniques to balance the state of charge of the energy cells based on one or more algorithms programmed into the control circuit.

According to some examples, the control circuit may detect failure of a switching module such as an open or short in the switching circuit S of the switching module. The control circuit may detect the defective switching module in response to the energy cell not balancing charge or not shuttling charge as expected when activated. In response to detecting a defective switching module, the control circuit may isolate the energy cell attached to the defective switching module.

FIG. 11 shows an example of an energy cell system with a defective shuttling switching module W05. A short in the shuttling switching module W05 may result in a permanent imbalance in the potential difference across the two strings, which may result in a risk of overcharging of the cell segment of A1-A4 and the cell segment of B6-B12. In response to detecting the failure of switching module W05, the control circuit isolates energy cells A5 and B5, and switching module W05, by simultaneously activating equipotential switching modules X04 and X05. This allows the A5 and B5 energy cells to gradually discharge to a low state of charge or zero charge.

FIGS. 12A and 12B are block diagrams of examples of dual energy cell systems. A dual energy cell system is a dual energy storage system having two different types of energy cells. The types of energy cells in a dual energy cell system are not limited to traditional battery cell types. The dual energy cell systems in FIGS. 12A and 12B include an energy cell string 1232 of Lithium-Ion batteries and an energy cell string 1240 of Ultra-Capacitors. The outputs of the energy cell strings are provided for power conversion 1242.

Because of the difference in energy cell types, the energy cell strings are not directly connected in parallel due to unmatching energy cell voltages and string voltages. To connect the two energy cell strings, a direct-current (DC) to DC converter 1244 is included and connected to the Ultra-Capacitor cell string to convert the output of the Ultra-Capacitor cell string to the same voltage as the Li-Ion battery cell string. In FIG. 12B, the DC-to-DC converter 1244 is connected to the Li-Ion battery cell string to convert the output of the Li-Ion battery cell string to the same voltage as the Ultra-Capacitor cell string.

FIG. 13 is a block diagram of another example of a dual energy cell system 1320. The energy cells in FIG. 13 represent two energy cell strings 1332, 1340 of different energy cell types. The energy cell types differ between the two strings in one or both of their cell chemistry composition and their internal cell design. For instance, energy cell string 1332 may have energy cells designed for higher energy density and the energy cells may have a thick and dense electrode design with a higher internal resistance. The other energy cell string 1340 may have energy cells designed for high-power capability and the energy cells may have a thin and porous electrode design for lower resistance and higher ion mobility. The two energy cell types may be different battery cell types. One battery cell type may be one of LIB, SIB, PbA battery, Ni—Zn battery, Metal-Air battery, or SSB, and the other battery cell type may be a different one of the LIB, SIB, or PbA battery, Ni—Zn battery, Metal-Air battery, or SSB types. In another example, the one energy cell type may be a type of battery cell and the other energy cell type may be a capacitive cell (e.g., LiCap, SuperCap, UCap, etc.).

FIG. 14 shows graphs of the open circuit voltage profiles as a function of state of charge for two types of energy cells. Graph 1405 shows voltage as function of state of charge for an SSB, and graph 1410 shows voltage as function of state of charge for an asymmetric super capacitor. The SSB may be the energy cell type of higher energy string 1332 in FIG. 13, and the asymmetric capacitor may be the energy cell type of higher power energy string 1340 in FIG. 13. The SSB cell has a voltage of about 4.2 volts (4.2V) at the fully charged state (state of charge of 1.00) and the asymmetric capacitor cell has a voltage of about 3.0V at the fully charged state.

Note that in the example of FIG. 13, the energy cell strings 1332, 1340 are directly connected in parallel even though FIG. 14 shows that the energy cells of the two strings will have unmatching voltages. To directly connect the two strings, the number of energy cells in each string is selected so that the total voltages of the strings are matched to within a specific range of a complete state of charge. For example, the number and type of energy cells for higher energy string 1332 can be selected to operate within the complete range of 0% to 100% of the desired state of charge, and the number and type of energy cells for higher power string 1340 can be selected to operate within 10% to 90% of the complete state of charge. To enable direct parallel connection of the energy cell strings 1332, 1340, the energy cells of the two strings are connected using a network of switching modules similar to the system of FIG. 3. The switching modules provide balancing of the state of charge of the energy cells of the two strings. The cell balancing of the higher energy string 1332 may be given priority than the higher power string 1340 to ensure a maximum of total available energy of the energy cell system 1320.

FIG. 15 is an illustration of another example of a dual energy cell system 1520. The system includes a higher energy string 1532 having twelve higher energy cells labeled V-E1 to VE-12, and a higher power string 1540 having eighteen higher power cells labeled V-P1 to VP-18. The cells of the string 1532 may be SSB cells and the cells of string 1540 may be asymmetric capacitor cells. In the fully charged state, the voltage of the SSB cells is about 4.2V and the voltage of the energy cell string 1532 is about 50.4V at 100% state of charge. This voltage corresponds to a state of charge of about 88% of the eighteen cells string 1540 (eighteen cells at about 2.8V at 88% SoC).

FIG. 16 is an illustration of the dual energy cell system 1520 of FIG. 15 with the internal network of switching modules to enable inter-cell charge balancing. The switching modules include equipotential switching modules X01-X05. The equipotential switching modules group the energy cells of each string into cell segments of two series connected cells for string 1532 (8.4V at 100% SoC) and three series connected cells for string 1540 (8.4V at 88% SoC). The equipotential switching modules enable equalization of the two-cell segments and the three-cell segments. The switching modules include a first set of shuttling switching modules labeled S01 to S11 that allow current to flow from the energy cells of string 1532 to the energy cells of string 1540. The switching modules also include a second set of shuttling switching modules labeled W01 to W11 that allow current to flow from the energy cells of string 1540 to the energy cells of string 1532. Activation of multiple switching modules enables balancing of different combinations of cell segments of the energy cell strings.

### INDUSTRIAL APPLICABILITY

FIG. 17 is a flow diagram of an example of a method 1700 of operating a dual energy cell system having two energy cell strings connected directly in parallel. The method 1700 may be performed using the dual energy cell system 1520 of FIG. 16. As in the example of FIG. 16, each energy cell string includes multiple energy cells of a different energy cell type connected in series.

At block 1705, the energy cells of the first energy cell string and the second energy cell string are charged. FIG. 18 is an illustration of an example of an initial charged condition and the switching modules of the dual energy cell system 1520 of FIG. 16. The example includes the individual cell voltage 1850, cumulative string voltage 1852, the individual cell state of charge 1854, and the average cell state of charge of the string (SOC_{AVG}). The dual energy cell system 1520 may then be discharged to drive a load such as a work machine for example.

At block 1710 in FIG. 17, the control circuit identifies the energy cells of a first cell segment of an energy cell string that have a voltage lower than a specified low voltage threshold. The first cell segment may include one or more energy cells. The detection of the low voltage may occur after charging or from time to time after discharging begins.

At block 1715, the control circuit connects a second cell segment from the other energy cell string that has a voltage higher than the threshold to the first cell segment to change the state of charge of the first cell segment. The second cell segment has a different type of energy cell than the first cell segment and may have a different number of energy cells than the first cell segment. At block 1720, the control circuit disconnects the second cell segment from the first cell segment when detecting that the state of charge between the two cell segments is balanced.

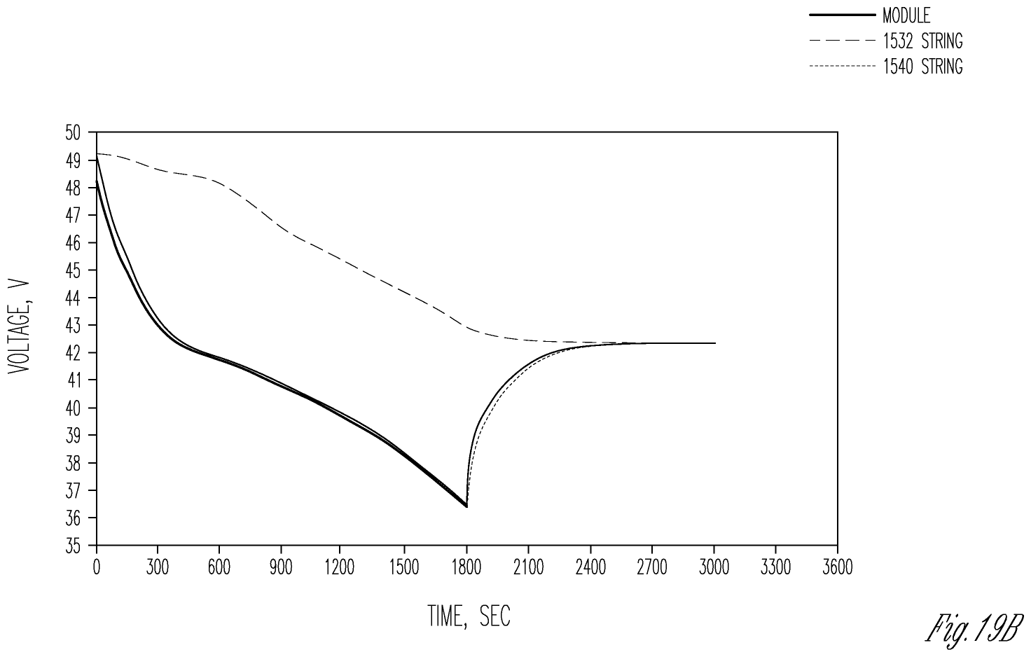

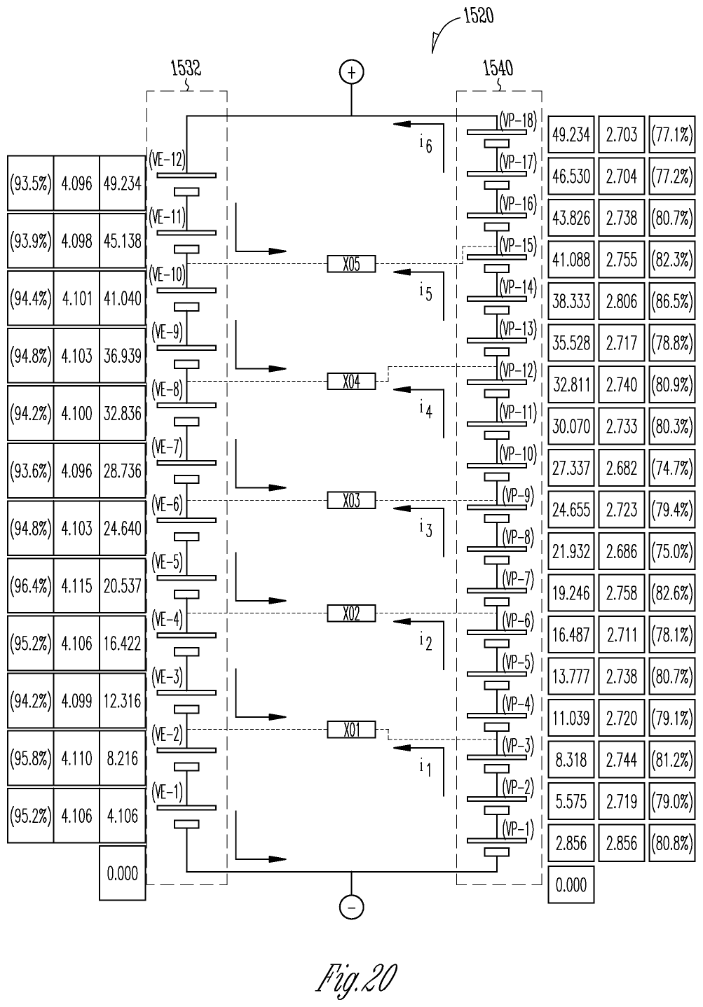

FIGS. 19A and 19B are graphs of the simulated response of a constant-current discharge profile of the dual energy cell system of FIG. 16. Energy cell string 1532 starts at about 95%±1% SoC and energy cell string 1540 starts at about 79.7%±2.8% SoC. The graphs show that during the initial discharge phase of the energy cell system (approximately the first 300 seconds) the majority of power (or current) is discharged through the higher power cells of string 1540 until the average cell of the string 1540 drops to about 40% SoC, and then the remaining energy is discharged mainly through higher energy density cells of string 1532. There is no switching module between the two strings. Current flows neutrally from the energy string 1532 to power string 1540 because the equilibrium voltage of the higher SoC string in 1532 is higher than the equilibrium voltage of the low SoC string 1540 at the end of the discharge. As soon as the external current is removed (i.e., stop discharge), the potential difference between the two strings causes the current to flow immediately from the string 1532 to string 1540 and the current flow is only limited by the internal resistance of the cells of the strings.

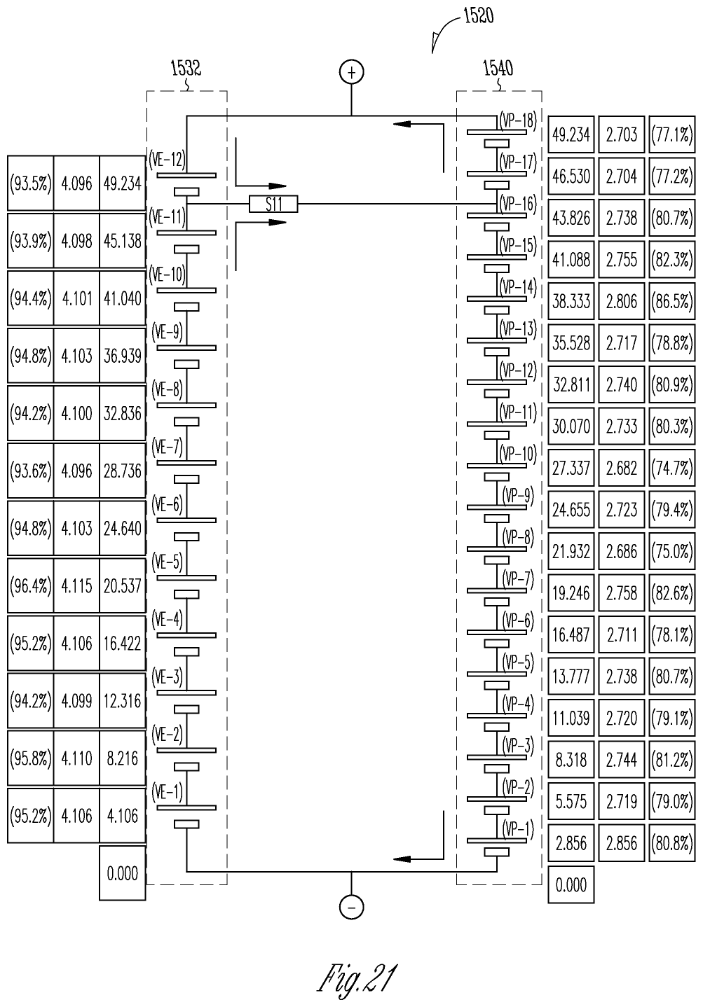

FIG. 20 is an illustration of an example of charge equalization of individual cell segments of the strings 1532, 1540 using the equipotential switching modules (X01-X05) of the dual energy cell system 1520 of FIG. 16. Activation of the equipotential switching modules by the control circuit balances six cell segments of each of the strings, with the each of the cell segments of string 1532 having a different number of cells (two cells) than the cell segments of string 1540 (three cells). The example of FIG. 20 illustrates the charge and discharge currents (i₁-i₆) that may flow between string 1532 and string 1540 until the voltages of the six cell segments of the two strings are equalized. Charging and discharging of the cell segments is limited by the overall internal resistance of the cells of each equalization path.

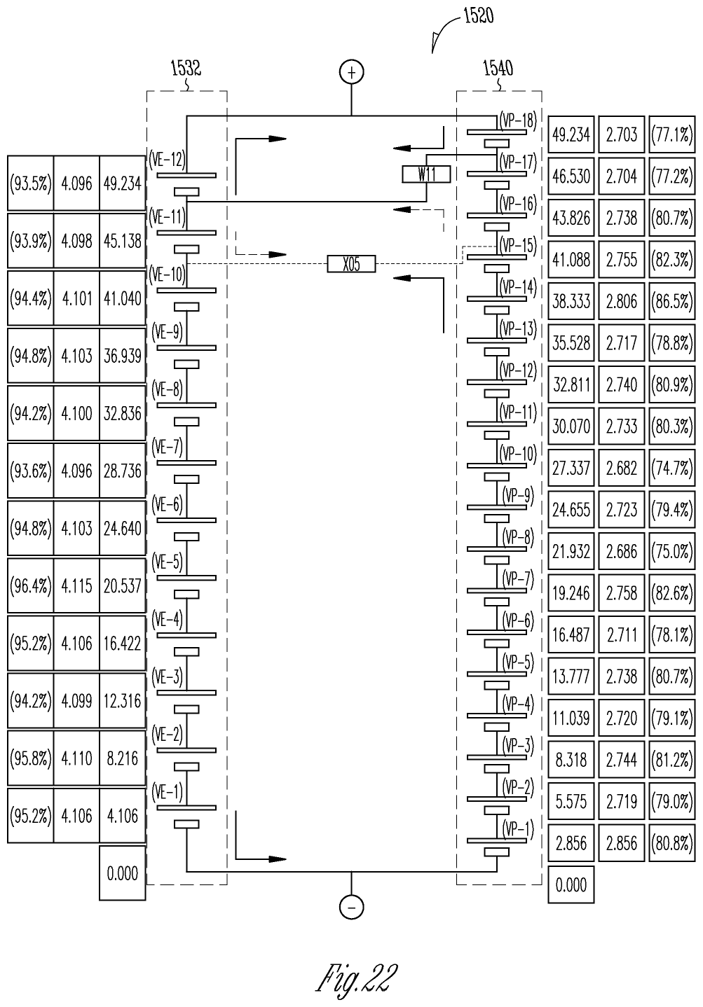

FIG. 21 is an illustration of an example of activating a single shuttling switching module (S11) to shuttle charge from string 1532 to string 1540. Activation of the switching module causes current to flow by forcing a potential difference across the one-cell segment (VE-12) of string 1532 and the two-cell segment (VP-18 to VP-17) of string 1540.

FIG. 22 is an illustration of an example of activating multiple switching modules including an equipotential switching module (X05) and a shuttling switching module (W11). The activation of the switching modules by the control circuit enables energy cell balancing between a single cell of string 1532 (VE-12) and a single cell of string 1540 (VP-18). The activation of switching modules also enables energy cell balancing between a two-cell segment of string 1540 (VP-17 to VP-16) and a one-cell segment of string 1532 (VE-11).

Activation of multiple switching modules enables balancing of different combinations of cell segments of the energy cell strings. The balancing is achieved without a DC-to-DC converter in either of the cell strings. The balancing is also achieved without additional temporary charge storage devices (e.g., capacitors or inductors). The interconnected energy cell network allows the energy cells themselves to be the storage devices used to shuttle charge between energy cells, energy cell segments, and energy cell strings. The combination of switching module settings, the sequence of activating the switching modules, and the duration of activating the switching modules may be optimized using an equivalent circuit model for the energy cells for simulation. The control circuit may then be configured (e.g., by programming) with an algorithm determined for optimized activation under different cell imbalance scenarios.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. An energy cell system, the system comprising:
multiple energy cell strings, wherein an energy cell string includes multiple energy cells connected in series;
multiple switching modules connected between the multiple energy cells of different energy cell strings; and
a control circuit configured to:
detect a charge level of a first subset of one or more energy cells of a first energy cell string;
activate a switching module to connect a second subset of one or more energy cells of another energy cell string to the first subset of energy cells to change the charge level of the first subset of energy cells; and
deactivate the switching module in response to the change in the charge level of the first subset of energy cells.

2. The system of claim 1, wherein the multiple energy cell strings each include multiple battery cells of a same battery cell type connected in series.

3. The system of claim 1,
wherein the first energy cell string includes a same number of energy cells as the other energy cell string, and an energy cell of the first energy cell string has a corresponding parallel energy cell in the other energy cell string; and
wherein the multiple switching modules include a first switching module connecting a cathode of an energy cell of the first energy cell string to a cathode of a corresponding parallel energy cell of the other energy cell string.

4. The system of claim 3, wherein the multiple switching modules include:
a second switching module connecting a cathode of an energy cell of the first energy string to an anode of the corresponding parallel energy cell of the other energy string; and
a third switching module connecting an anode of the energy cell of the first energy string to a cathode of the corresponding parallel energy cell of the other energy string.

5. The system of claim 1,
wherein a switching module includes at least one switch circuit; and
wherein the control circuit is configured to detect a defective switch circuit of a first switching module and activate a switch circuit of a second switching module to bypass the defective switch circuit.

6. The system of claim 1,
wherein the first energy cell string includes a first type of energy cells having an internal cell chemistry and internal cell electrodes; and
wherein the other energy cell string includes a second type of energy cell that is different from the first type of energy cell in one or both of the internal cell chemistry and the internal cell electrodes.

7. The system of claim 6, wherein the first energy cell string includes a string of capacitive cells, and the other energy cell string includes a string of battery cells.

8. The system of claim 6, wherein the first energy cell string includes a first number of energy cells, and the other energy cell string includes a different number of energy cells.

9. The system of claim 6, wherein the first energy cell string is directly connected in parallel to the other energy cell string.

10. The system of claim 6, wherein the first type of energy cells has lower internal resistance than the second type of energy cells.

11. The system of claim 6,
wherein the first subset of energy cells includes a first number of energy cells, and the second subset of energy cells includes a different number of energy cells than the first subset of energy cells; and
wherein a first switching module is connected to a cathode of a first energy cell of the first subset and a cathode of a first energy cell of the second subset, a second switching module is connected to an anode of the first energy cell of the first subset and an anode of the first energy cell of the second subset, and a third switching module is connected to the anode of the first energy cell of the first subset and to an anode of a second energy cell of the second subset.

12. The system of claim 1, wherein the multiple switching modules include:
a first set of switching modules that, when activated, balances connected energy cells of the first energy cell string and the second energy cell string to a same voltage potential;
a second set of switching modules that, when activated, causes current to flow to an energy cell of the first string from an energy cell of the other string; and
a third set of switching modules that, when activated, causes current to flow to an energy cell of the other string from an energy cell of the first string.

13. A method of operating an energy cell system having multiple energy cell strings of multiple energy cells connected in series, the method comprising:
detecting a state of charge of a first subset of one or more energy cells of a first energy cell string;
connecting a second subset of one or more energy cells of a second energy cell string to the first subset of energy cells to change the state of charge of the first subset of energy cells; and
disconnecting the second subset of energy cells from the first subset of energy cells in response to the change in the state of charge of the first subset of energy cells.

14. The method of claim 13, including:
charging the energy cells of the first energy cell string;
charging the energy cells of the second energy cell string;
wherein the detecting the state of charge includes identifying energy cells of the first energy cell string that have a voltage lower than a specified low voltage threshold after the charging of the first energy cell string; and
wherein the connecting the second subset of one or more energy cells includes connecting energy cells having a voltage higher than the specified low voltage threshold to the identified energy cells of the first energy cell string.

15. The method of claim 13,
wherein the detecting the state of charge of the first subset of energy cells includes detecting the state of charge of a first type of energy cells; and
wherein the connecting the second subset of energy cells includes connecting a different type of energy cells to the first subset of energy cells to change the state of charge of the first type of energy cells.

16. The method of claim 13,
wherein the detecting the state of charge of the first subset of energy cells includes detecting the state of charge of a first number of energy cells of the first subset of energy cells; and
wherein the connecting the second subset of energy cells includes connecting a different number of energy cells to the first number of energy cells to change the state of charge of the first number of energy cells.

17. The method of claim 13,
wherein the detecting the state of charge of the first subset of energy cells includes detecting the state of charge of capacitive cells of the first energy cell string; and
wherein the connecting the second subset of energy cells includes connecting battery cells of the second energy cell string to the capacitive cells of the first energy cell string to change the state of charge of the capacitive cells of the first energy cell string.

18. The method of claim 13, including:
detecting a failure in a switching module connecting an energy cell of the first energy cell string to an energy cell of the second energy cell string; and
isolating the energy cell of the first energy cell string from other energy cells of the first energy cell string.

19. A non-transitory computer-readable storage medium including instructions that, when performed by a hardware processor of an energy cell system including multiple energy cell strings, cause the energy cell system to perform operations comprising:
detecting a state of charge of a first subset of one or more energy cells of a first energy cell string of the energy cell system;
connecting a second subset of one or more energy cells of a second energy cell string to the first subset of energy cells to change the state of charge of the first subset of energy cells; and
disconnecting the second subset of energy cells from the first subset of energy cells in response to the change in the state of charge of the first subset of energy cells.

20. The non-transitory computer-readable storage medium of claim 19, further including instructions that cause the energy cell system to perform operations including:
receiving a command to bring the energy cell system to a charged state;
charging the energy cells of the first energy cell string;
charging the energy cells of the second energy cell string;
identifying energy cells of the first energy cell string that have a voltage lower than a specified low voltage threshold after the charging of the first energy cell string; and
connecting energy cells of the second energy cell string having a voltage higher than the specified low voltage threshold to the identified energy cells of the first energy cell string.
